(19) United States
(12) Patent Application Publication
(10) Pub. No.: US 2013/0298412 A1
(43) Pub. Date: Nov. 14, 2013

(54) EXTENDIBLE SHAVER DEVICE

(71) Applicant: Richard Harski, Mobile, AL (US)

(72) Inventor: Richard Harski, Mobile, AL (US)

(21) Appl. No.: 13/469,025

(22) Filed: May 10, 2012

(51) Int. Cl. B26B 21/52

(52) U.S. Cl. 30/526

(57) ABSTRACT

The present invention is an extendible shaver device that includes a curved plastic handle that is grasped by a user with a distal end, a standard hand razor with a relatively small gap that is utilized to shave back hair of the user and a receptacle area that includes a raised area disposed on a distal end of the curved handle and removably secures the standard razor in place, wherein the raised area receives the small gap of the standard razor that allows the user to snap and removably secure the standard razor into the raised area.

### TECHNICAL FIELD & BACKGROUND

Currently there are a number of ways for an individual to eliminate back hair. The back hair can be waxed off, shaved or electrolysis may be employed. It can be difficult to shave an individual's upper rear without assistance also, since wax can be painful and leave behind red marks, while electrolysis can be expensive.

The present invention generally relates to a shaver device. More specifically, the invention is an extendible shaver device.

It is an object of the invention to provide an extendible shaver device that can be used by a user to shave their own back by themselves.

It is an object of the invention to provide an extendible shaver device that eliminates a need to have a user's back hair removed professionally.

It is an object of the invention to provide an extendible shaver device that is more comfortable to use to remove a user's back hair than other types of hair removal methods and devices.

What is really needed is an extendible shaver device that can be used by a user to shave their own back by themselves that eliminates a need to have a user's back hair removed professionally that is more comfortable to use to remove a user's back hair than other types of hair removal methods and devices.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side view of an extendible shaver device, according to an embodiment of the present invention.

FIG. 1B illustrates a front view of a receptacle area of an extendible shaver device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

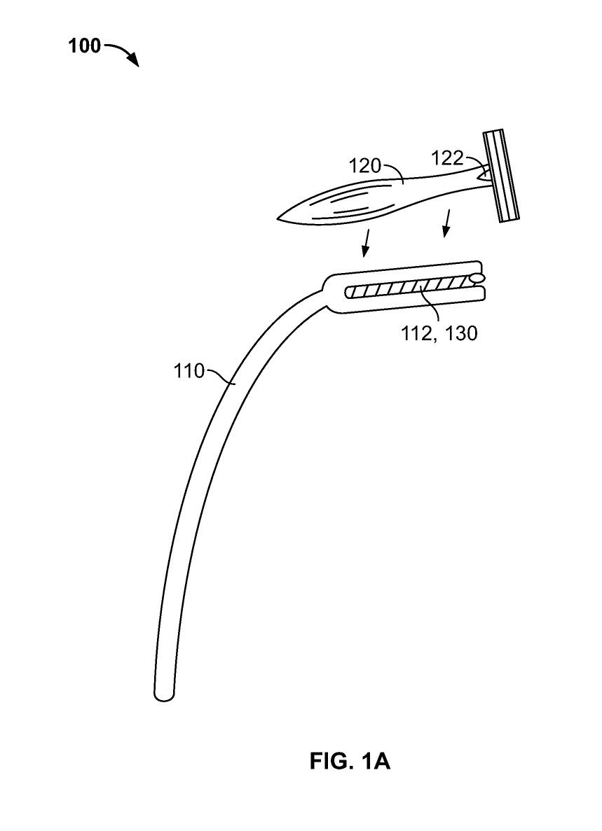

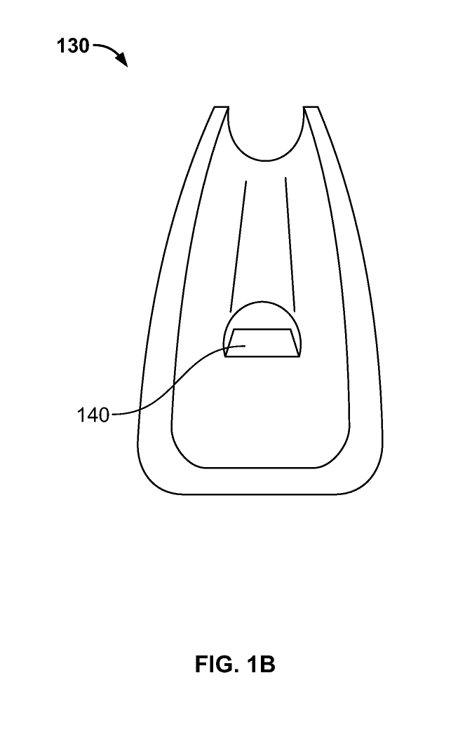

FIG. 1A illustrates a side view of an extendible shaver device 100, according to an embodiment of the present invention. The extendible shaver device 100 can be used by a user to shave their own back by themselves that eliminates a need to have a user's back hair removed professionally that is more comfortable to use to remove a user's back hair than other types of hair removal methods and devices. The extendible shaver device 100 can also be utilized to remove hair and shave any other suitable part of a user's body such as an upper rear end.

The extendible shaver device 100 includes a curved handle 110, a standard hand razor 120 and a receptacle area 130. The curved handle 110 has a distal end 112 that is grasped by a user to utilize the extendible shaver device 100. The curved handle 110 is made of plastic that is relatively lightweight plastic but can be made of other suitable materials as well. The curved handle 110 is in the range of 11 to 14 inches in length but can be other suitable lengths as well. The standard hand razor 120 has a relatively small gap 122 and is utilized to shave any type of hair of a user and is typically utilized to shave a user's back hair. The receptacle area 130 is disposed on the distal end 112 of the curved handle 110 and removably secures the standard razor 120 in place. Typically the standard razor 120 is simply snapped into place into the receptacle area 130. The receptacle area 130 is illustrated and described in additional detail in FIG. 1B and its description.

FIG. 1B illustrates a front view of a receptacle area 130 of an extendible shaver device 100, according to an embodiment of the present invention. The receptacle area 130 is a similar receptacle described and illustrated in FIG. 1A and its description. The receptacle area 130 includes a raised area 140. The raised area 140 receives the relatively small gap 122 of the standard razor 120 that allows a user to snap and removably secure the standard razor 120 into the raised area 140 of the receptacle area 130.

The extendible shaver device 100 is approximately in the range of 12 to 14 inches long with a diameter of approximately 2 cm. The extendible shaver device 100 is less than approximately 12 ounces in weight.

The extendible shaver device is a self-grooming tool for men. The extendible shaver device is a relatively lightweight device that includes an approximate 11″ to 14″ handle in length with a razor fastened to its distal end for quick and easy removal of hair. A receptacle area with a raised design allows for a plurality of standard different brand name razors to snap into place. To utilize the extendible shaver device, a user typically stands in front of a mirror while holding another mirror and positions the mirrors to ensure the appropriate area is shaved. Newspaper can also be placed on the floor for easy clean-up later. The extendible shaver device may be readily available at retail stores where grooming accessories are sold. The extendible shaver device features an approximate 11″ to 14″ long, relatively lightweight handle with razor attached to remove hair in difficult to reach places. The extendible shaver device is designed with a curved head for well suited razor to hair contact.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An extendible shaver device, comprising:
a curved handle with a distal end that is grasped by a user to utilize said extendible shaver device;
a standard hand razor with a small gap that is utilized to shave any type of hair of said user; and
a receptacle area that includes a raised area disposed on said distal end of said curved handle and removably secures said standard razor in place.

2. The device according to claim 1, wherein said curved handle is made of plastic.

3. The device according to claim 1, wherein said curved handle is in the range of 11 to 14 inches in length.

4. The device according to claim 1, wherein said hair type is back hair.

5. The device according to claim 1, wherein said raised area receives said small gap of said standard razor that allows said user to snap and removably secure said standard razor into said raised area.

6. The device according to claim 1, wherein said extendible shaver device is approximately in the range of 12 to 14 inches in length.

7. The device according to claim 1, wherein said extendible shaver device has a diameter of approximately 2 cm.

8. An extendible shaver device, comprising:
a curved plastic handle with a distal end that is grasped by a user to utilize said extendible shaver device;
a standard hand razor with a small gap that is utilized to shave any type of hair of said user; and
a receptacle area that includes a raised area disposed on said distal end of said curved handle and removably secures said standard razor in place.

9. The device according to claim 8, wherein said curved handle is in the range of 11 to 14 inches in length.

10. The device according to claim 8, wherein said hair type is back hair.

11. The device according to claim 8, wherein said raised area receives said small gap of said standard razor that allows said user to snap and removably secure said standard razor into said raised area.

12. The device according to claim 8, wherein said extendible shaver device is approximately in the range of 12 to 14 inches in length.

13. The device according to claim 8, wherein said extendible shaver device has a diameter of approximately 2 cm.

14. The device according to claim 8, wherein said extendible shaver device is less than approximately 12 ounces in weight.

15. An extendible shaver device, comprising:
a curved plastic handle with a distal end that is grasped by a user to utilize said extendible shaver device;
a standard hand razor with a small gap that is utilized to shave back hair of said user; and
a receptacle area that includes a raised area disposed on said distal end of said curved handle and removably secures said standard razor in place, wherein said raised area receives said small gap of said standard razor that allows said user to snap and removably secure said standard razor into said raised area.

16. The device according to claim 15, wherein said curved handle is made of lightweight plastic.

17. The device according to claim 15, wherein said curved handle is in the range of 11 to 14 inches in length.

18. The device according to claim 15, wherein said extendible shaver device is approximately in the range of 12 to 14 inches in length.

19. The device according to claim 15, wherein said extendible shaver device has a diameter of approximately 2 cm.

20. The device according to claim 15, wherein said extendible shaver device is less than approximately 12 ounces in weight.
